(19) United States
(12) Patent Application Publication
(10) Pub. No.: US 2017/0029343 A1
(43) Pub. Date: Feb. 2, 2017

(54) SULFUR ENHANCED NITROGEN PRODUCTION FROM EMISSION SCRUBBING

(71) Applicant: Terrell D. Ginn, Milton, KY (US)

(72) Inventor: Terrell D. Ginn, Milton, KY (US)

(73) Assignee: Terrell D. Ginn, Milton, KY (US)

(21) Appl. No.: 15/060,065

(22) Filed: Mar. 3, 2016

Related U.S. Application Data
(60) Provisional application No. 62/197,482, filed on Jul. 27, 2015.

(51) Int. Cl. C05C 1/00; B01D 53/18; C05G 1/00; B01D 53/62; B01D 53/78; B01D 53/14; B01D 53/50

(52) U.S. Cl. CPC C05C 1/00; B01D 53/1481; B01D 53/1493; B01D 53/18; B01D 53/1475; B01D 53/502; B01D 53/62; B01D 53/78; C05G 1/00; B01D 2252/102; B01D 2252/50; B01D 2251/10; B01D 2258/0283; B01D 2251/404; B01D 2252/2053

(57) ABSTRACT

A fertilizer product is produced by a method of removing sulfur from flue gas. The method includes: introducing a flue gas stream to a wet scrubber; contacting the flue gas stream with a liquid nitrogen reagent in the wet scrubber that deposits in a bottom portion of the wet scrubber as a liquid fraction and possibly contacting the liquid fraction from the wet scrubber with an oxidizing gas; discharging reacted liquid nitrogen product from the wet scrubber that contains sulfur removed from the flue gas stream and that comprises a nitrogen and sulfur enriched fertilizer solution; and discharging flue gas exhaust from the wet scrubber.

### CROSS-REFERENCE TO RELATED APPLICATION

This application claims priority or the benefit of U.S. Provisional Application 62/197,482, entitled “SULFUR ENHANCED NITROGEN PRODUCTION FROM EMISSION SCRUBBING”, filed Jul. 27, 2015, the contents of which are fully incorporated herein by reference.

### BACKGROUND OF THE INVENTION

1. Field of the Invention

The present disclosure relates to a process for the utilization of nitrogen products for removal of SO₂ and CO₂ from a power plant emission stream and production of a liquid sulfur enriched nitrogen product.

2. Description of the Related Art

Federal, state and even some local governments have laws regulating the emission of particulates, gases and other contaminants present in gas produced in coal combustion. To comply with these laws, industries must implement systems that reduce or eliminate emissions of particulates and/or gases that have been deemed harmful to the environment.

Several technologies and processes have been developed to reduce emissions of such elements. These technologies include desulfurization systems that employ fabric filters, electrostatic precipitators, and wet scrubbers. Desulfurization systems have shown sufficient efficiency in the removal of particulate and gases.

One desulfurization system is the wet flue gas desulfurization system. Wet flue gas desulfurization systems (WFGD) purify flue gas, which is produced by coal combustion. There are several known designs for WFGD systems. One example of a WFGD system uses small droplets of slurry that contain water and alkaline material, such as lime or limestone, which is sprayed into the flue gas. Another example of a WFGD system bubbles the flue gas through a bed of slurry to remove pollutants. Regardless of the design of the WFGD system, the slurry reacts with sulfur oxides (SOx) present in the flue gas and removes them from the flue gas stream as precipitated compounds.

Besides the removal of SOx from the flue gas stream, the WFGD system also captures HCl and HF gases, which are removed from the flue gas stream and become water soluble salts: CaCl2 and CaF2, respectively. These salts dissociate and yield free Cl— and F— ions which build up in the WFGD system. This buildup can cause corrosion and other damage in the WFGD system, and can negatively affect SOx removal.

Typically, a stream of water or other liquid, or a slurry containing liquid and particles, referred to as a purge liquid, is used to purge chlorides and other unwanted compounds from the WFGD system. The purge liquid helps maintain a desired chloride concentration, which in turn, helps to protect the equipment of the WFGD system from corrosion. The purge liquid is typically diverted to a wastewater treatment facility.

Typically, wastewater treatment facilities used in conjunction with WFGD systems are expensive. The design and supply cost of such a facility can exceed the cost of other systems used in connection with the WFGD plant. The cost of the wastewater treatment facility is even more pronounced when organic acids are used in the WFGD system.

The term wet scrubber describes a variety of devices that remove pollutants from a furnace flue gas or from other gas streams. In a wet scrubber, the polluted gas stream is brought into contact with the scrubbing liquid, by spraying it with the liquid, by forcing it through a pool of liquid, or by some other contact method, so as to remove the pollutants.

Synthetic gypsum, sometimes referred to as flue-gas desulfurization (FGD) gypsum, is a by-product recovered from flue gas streams resulting from the burning of energy sources containing high concentrations of sulfur (e.g. coal). FGD systems can generate large quantities of products, which must be placed in landfills, deposited in surface impoundments, or beneficially recycled. Much of the synthetic gypsum produced is utilized in the wallboard industry. However, the production of synthetic gypsum is rapidly increasing as more coal-fired power plants come online and as new scrubbers are added to existing power plans in order to comply with Environmental Protection Agency (EPA) regulations. A need exists for the removal of sulfur and CO2 from the emission stream while reducing the amount of by-product gypsum landfilling.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a block diagram of an optionally two-stage wet flue gas desulfurization (WFGD) system, according to one or more embodiments;

FIG. 2 illustrates a flow diagram of a method of WFGD, according to one or more embodiments;

FIG. 3 illustrates a block diagram of a one-stage WFGD system, according to one or more embodiments;

FIG. 4 illustrates a flow diagram of a method of WFGD using single stage scrubbing, according to one or more embodiments;

FIG. 5 illustrates a flow diagram of a method of WFGD using NH3 (Aqua Only), according to one or more embodiments;

FIG. 6 illustrates a flow diagram of a method of WFGD using (NH2)2CO+NH4NO3+H2O+CaCO3, according to one or more embodiments; and

FIG. 7 illustrates a flow diagram of a method of WFGD using a limestone water stage, according to one or more embodiments.

### DETAILED DESCRIPTION

Embodiments of the present innovation are directed to the utilization of a liquid nitrogen containing reagent, such as urea-ammonium nitrate (UAN):(NH₂)2CO+NH₄NO₃+H₂O and/or anhydrous ammonia and/or aqueous ammonia for removal of sulfur dioxide (SO₂) and carbon dioxide (CO₂) from power plant emission stream and producing a liquid sulfur enriched nitrogen product. In a first aspect of the present disclosure, liquid nitrogen is brought into the plant. The nitrogen is either used alone or added to another agent such as but not limited to anhydrous ammonia, aqua ammonia, calcium carbonate, magnesium oxide or other agent or some combination of the before mentioned which may improve the efficiency of the removal and enrichment of the output product. The liquid is then captured and the product is then removed from the plant and used in agriculture production. It may need to be oxidized, dewatered or other as deemed necessary to make the desired product.

A liquid nitrogen solution typically would not be economically feasible to use as a scrubbing agent. However, its value when captured after the scrubbing and being enhanced with sulfur would be valuable to agriculture. Some farmers are paying significant dollar amounts to apply nitrogen and sulfur to their crops. Sulfur is an elemental necessary for crop production and the amount of SO₂ deposition from the air has diminished dramatically since the implementation of the Clean Air Act. Today's agriculture crops have increased sulfur consumption due to increased yields and higher yielding hybrids. With the increased sulfur crop consumption, depleted levels in the soil and reduced SO2 deposition due to the Clean Air Act, it has become necessary for the agriculture community to purchase supplemental sulfur for crops.

Another benefit of the process is that there may be removal of some or all CO₂ from the emissions. The International Energy Agency (IEA) says that, to have a 50 percent chance of avoiding 2° C. of global warming, which is probably too dangerous to adapt to, the energy sector can only emit 884 gigatonnes of CO₂ between 2013 and 2050 (Redrawing the Climate—Energy Map, 2013). Burning proven reserves of coal, oil and gas would release 2860 Gt. So we must leave two-thirds in the ground (Technology Roadmap: Carbon Capture and Storage, 2013). In some embodiments of the method, the liquid product may be removed after oxidation, if needed, from the scrubbing system and used as is in agriculture production

In some embodiments of the method, the solution in the scrubber may need to be dewatered (water and nitrogen removed) and further processed. In some embodiments of the method, the material may be used as an agricultural product without removal of excess nitrogen and water. In some embodiments, the method further includes feeding an additive to the scrubbing solution. The additive can include at least one of magnesium oxide, calcium carbonate from limestone, boron, zinc, sulfur or other additive products.

In some aspects of the present disclosure, an enhanced fertilizer is provided by the system. The output solution may include synthetic gypsum, magnesium oxide and/or other agents to either increase scrubbing efficiency or for agriculture value and usage enhancement.

In some embodiments of the present disclosure, an additive with claims to enhance the value in agriculture by making the nitrogen more stable may be added. In some embodiments of the present disclosure, additional aqueous ammonia (NH₃) may need to be added either with the nitrogen solution or in a sequential or later application to improve CO₂ capture and removal. The resulting removed product if done separately will be mixed with the scrubbed solution mentioned above.

The liquid nitrogen fraction is an ammonia/urea combination with varying percentage of nitrogen solutions and is used widely in the agriculture community. With the implementation of the Clean Air Act, higher yielding crops, depletion of soils and other factors sulfur is becoming a common fertility input in agriculture production. In addition, many times a sulfate form of sulfur is preferred as it can be utilized by the plant whereas the elemental form has to be broken down in the soil to the sulfate form. The oxidation at the flue gas emissions point (or in the scrubber, etc.) converts the sulfur to the sulfate form.

The processes and systems described herein are typically used in coal-combustion systems, however it is foreseeable to use such processes and systems in waste-to-energy plants, and other facilities that produce a flue gas stream. The capture methods of the present disclosure may be applied to various environments. In some embodiments, the environment may include at least one of an industrial gas stream, natural gas stream, or a flue gas stream. In some embodiments, the environment is an industrial gas stream. In some embodiments, the environment is a natural gas stream. In some embodiments, the composite material is within a structure that is further mounted in an underwater environment, such as a marine environment or a submarine environment or sub platform environment. In some embodiments, the environment is a flue gas stream. In some embodiments, the environment is an oil or gas field. In some embodiments, the environment that contains the CO₂ to be captured is a natural gas stream that contains methane, ethane, propane, or combinations of such gases. In some embodiments, the composite material is within a structure that is further mounted in a space vehicle or station.

In some embodiments, the limestone that is used as a regent along with the material removed by the desulphurization has to be disposed. Some of the material is used for beneficial uses, however, millions of tons of waste by-product each year have to be landfilled. In many of the embodiments of the present invention, the regent (nitrogen) along with the scrubbed material is removed from the facility and used beneficially for agriculture purposes. This saves the consumers billions of dollars and produces an environmentally friendly solution to the landfill issue.

Flue gas streams contain, among other things: ash particles, noxious substances and other impurities that are considered to be environmental contaminants. Prior to being emitted into the atmosphere via a smoke stack (“stack”), the flue gas stream undergoes a cleansing or purification process. In coal combustion, this purification process is normally a desulfurization system.

As used herein, “dry scrubber” refers to a flue gas treatment apparatus, which produces a dry waste product and a treated gas. Some dry scrubbers can involve wet reactants and/or processes, which are dried prior to removal from the apparatus, such as spray dryer absorbers, flash dryer absorbers, and circulating dry scrubbers.

As used herein, “wet scrubber” refers to a flue gas treatment apparatus that produces a wet waste product and a treated gas. Although wet and dry scrubbers can be used for primary particulate removal, in context of the present invention, the use of the terms “wet scrubber” and “dry scrubber” refer to flue gas desulfurization units rather than primary particulate removal unless specifically stated otherwise. Wet scrubbers can be used to remove sulfur oxides and particulates from a flue gas. A wide variety of wet scrubber configurations is known and can involve contacting the flue gas with a sprayed liquid, forcing the flue gas through a volume of liquid, and other similar methods.

As used herein, “primary particulate removal” refers to initial removal of a large portion of particulates from a flue gas. This particulate removal is typically a separate unit such as a baghouse, electrostatic precipitator, or other scrubbing device; however such can also be integrated into the coal fired combustion unit. It will be understood that later scrubbing or polishing steps can, and usually do, remove particulates not removed by the primary particulate removal step.

In wet scrubbing systems, the flue gas normally passes first through a fly ash removal device, either an electrostatic precipitator or a wet scrubber, and then into the SO absorber. However, in dry injection or spray drying operations, the SO is first reacted with the sorbent, and then the flue gas passes through a particulate control device.

Another important design consideration associated with wet FGD systems is that the flue gas exiting the absorber is saturated with water and still contains some SO. These gases are highly corrosive to any downstream equipment such as fans, ducts, and stacks. Two methods that may minimize corrosion are: (1) reheating the gases to above their dew point, or (2) using materials of construction and designs that allow equipment to withstand the corrosive conditions. Both alternatives are expensive. Engineers determine which method to use on a site-by-site basis.

Flue gas desulfurization (FGD) removes harmful acid gases, such as SOx, from fossil fuel combustion output. Sulfur oxides (SOx) may refer to any of lower sulfur oxides such as SO, S2O2, S2O, S3O, SxO (where x is 5-10), S₆O₂, S₇O₂, and polymeric sulfuroxides; sulfur monoxide (SO); sulfur dioxide (SO2); sulfur trioxide (SO3); and higher sulfur oxides such as SO₃+y (where 0<y1), or a combination thereof. The combustion of coal, oil, natural gas, or any other sulfur-containing fuels may produce a flue gas in which 98-99% of the sulfur is in the form of sulfur dioxide (SO₂) and 1-2% is sulfur trioxide (SO₃). For low and high sulfur coals the total concentration of SOx may be in the range of 1,000-4,000 ppm.

Embodiments of the present disclosure referenced above in which some, but not all, embodiments of the invention are disclosed may need to be modified as needed to enhance removal of sulfur or CO₂ removal or enhance the value to agriculture. Indeed, the present disclosure may be embodied in many different forms and should not be construed as limited to the embodiments set forth herein; rather, these embodiments are provided so that this disclosure may satisfy applicable legal requirements.

Liquid nitrogen is an ammonia/urea combination with varying percent nitrogen solutions and used widely in the agriculture community. With the implementation of the Clean Air Act, higher yielding crops, depletion of soils and other factors sulfur is becoming a common fertility input in agriculture production. In addition, many times a sulfate form of sulfur is preferred as the plant can utilize it whereas the elemental form has to be broken down in the soil to the sulfate form. The oxidation at the flue gas emissions point may enhance the production of the sulfate form. In some embodiments, a growing plant and power plant may be used in tandem in close proximity.

Synthetic gypsum, on the other hand, is generally produced in limestone-forced oxidation scrubbers that remove sulfur dioxide from the flue gas stream after coal combustion. In general, a wet scrubbing process first exposes the flue gases to a slurry of limestone and water. Capture of SO₂ by the lime slurry initially forms calcium sulfite (CaSO₃.0.5H₂O). Forcing additional air into the system oxidizes the calcium sulfite and converts it into gypsum, i.e., CaSO₄.2H₂O. During and after the oxidation process, washing of the by-product can remove some water-soluble elements such as boron (B). Generally, the final step of the gypsum production process involves partial removal of water by a use of centrifugation or vacuum filtration or both. The synthetic gypsum that is recovered is high quality and suitable for industrial (e.g., wallboard) uses. As noted above, the supply of synthetic gypsum is increasing due to more stringent environmental regulations coupled with the addition of new coal-fired power plants.

In some embodiments, it may be desirable to add a micronutrient mix to the liquid nitrogen for an improved fertilizer product. It is contemplated that any material may be added to the nitrogen solution depending upon the desired final product. Non-limiting example additives include zinc, manganese, iron, copper, and boron, nitrogen stabilizers or others.

In some embodiments of the present disclosure, anhydrous ammonia (92-0-0) (NH3) may be added to the scrubbing mix to increase efficiency of the agent or to change output product characteristics. In some embodiments of the present disclosure, another ammonia form derived from anhydrous ammonia may be used to increase efficiency and/or change output product characteristics. In some embodiments of the invention, anhydrous ammonia may need to be converted to aqua ammonia (NH₄OH(NH₃+H₂O) by mixing with water and mixed with the UAN to increase efficiency and/or product characteristics. In some embodiments of the invention, additional water may be used with the nitrogen reagents to increase scrubbing efficiency.

In some embodiments, one of five methods may be selectively employed as summarized in TABLE 1:

TABLE 1

| FGD Flow Diagram | FGD Flow Diagram | FGD Flow Diagram | FGD Flow Diagram | FGD Flow Diagram |
|---|---|---|---|---|
| Option 1: Two-Stage | Option 2: Single | Option 3: NH₃ | Option 4: (NH₂)₂CO + | Option 5: Limestone |
| Scrubbing. | Stage Scrubbing. | [Aqua Only] | NH₄NO₃ + H₂O + CaCO₃ | Water Stage 1. |
| Introduce the | Introduce the | Introduce the | Introduce the | Introduce the |
| flue gas stream | flue gas stream | flue gas stream | flue gas stream | flue gas stream |
| to a wet scrubber | to a wet scrubber | to a wet scrubber | to a wet scrubber | to a wet scrubber |
| Contact the flue | Contact the flue | Contact the flue | Contact the flue | Contact the flue |
| gas stream with | gas stream with | gas stream with | gas stream with | gas stream with |
| a UAN reagent | a UAN reagent | an ammonia | a CaCO₃/UAN | a CaCO₃ reagent |
| in the wet | in the wet | reagent in the | reagent in the | in the wet |
| scrubber | scrubber | wet scrubber | wet scrubber | scrubber |
| [(NH₂)₂CO + | [(NH₂)₂CO + | [NH₃ + H₂O] | [(NH₂)₂CO + | [CaCO₃ + H₂O] |
| NH₄NO₃ + H₂O] | NH4NO3 + H₂O] | | NH₄NO₃ + H₂O + | |
| | | | CaCO₃] | |
| Contact the | Contact the | Contact the | Contact the | Contact the liquid |
| liquid fraction | liquid fraction | liquid fraction | liquid fraction | fraction from the |
| from the wet | from the wet | from the wet | from the wet | wet scrubber with |
| scrubber with | scrubber with an | scrubber with | scrubber with an | an oxidizing gas |
| an oxidizing gas | oxidizing gas | an oxidizing | oxidizing gas | |
| (optional) | (optional) | gas (optional) | (optional) | |
| Discharge a | Discharge a | Discharge a | Discharge a | Collect the liquid |
| liquid fraction | liquid fraction | liquid fraction | liquid fraction | fraction from the |
| from the wet | from the wet | from the wet | from the wet | wet scrubber |
| scrubber | scrubber | scrubber | scrubber | [CaCO₃ + H₂O + |
| [(NH₂)2CO + | [(NH₂)2CO + | [NH₃ + H₂O + | [(NH₂)2CO + | SO₄ Aqua] |
| NH₄NO₃ + H₂O + | NH₄NO₃ + H₂O + | SO₄ Aqua] | NH₄NO₃ + H₂O + | |
| SO₄ Aqua] | SO₄ Aqua] | | CaSO₄ Aqua] | |
| | [NOx Aqua] | | | |
| Combine flue | | Combine flue | Combine flue | Combine flue gas |
| gas exhaust | | gas exhaust | gas exhaust with | exhaust with |
| containing CO₂ | | with optional | optional | optional secondary |
| with optional | | secondary NH₃ + | secondary NH₃ | NH₃ process |
| secondary NH₃ | | H₂O process | process | [NH₃ + CO₂ + |
| process | | | | OH Aqua] |
| | | | | Could be any of |
| | | | | these in secondary |
| | | | | process: |
| | | | | H₂O + NH₃ = |
| | | | | NH₄OH |
| | | | | H₂O + NH₃ = |
| | | | | NH₄ + OH |
| | | | | H₂O + NH₃ = |
| | | | | NH₄{+OH{−}+} |
| | | | | or |
| | | | | H2O + NH₃ + CO₂ = |
| | | | | (NH₄)₂CO3 |
| | | | | H₂O + NH₃ + CO₂ = |
| | | | | NH₄HCO₃ |
| Combine liquid | Collect the | Combine the | Combine the | Collect the liquid |
| fraction from | nitrogen- | liquid fraction | liquid fraction | fraction from the |
| scrubber with | containing | from the wet | with secondary | secondary process, |
| liquid traction | liquid | scrubber with | process [NH₃ + | which may include |
| from secondary | fraction | liquid from the | CO₂ + OH Aqua] | CO₂ and ammonia |
| process [NH₃ + | | secondary | | [and possibly |
| CO₂ + OH Aqua] | | process [NH₃ + | | Ammonium/Sulfate |
| | | CO₂ + OH Aqua] | | Solution] |
| Discharge | Discharge | Discharge flue | Discharge flue | Discharge flue |
| scrubbed air | cleaned flue | gas exhaust | gas exhaust | gas exhaust |
| from secondary | gas exhaust. | containing CO₂ | containing CO₂ | containing CO₂ |
| process. | | | | |

Referring to the processes of Table 1, note that that the system may not remove all CO₂ in some cases so some may be discharged under any of the options.

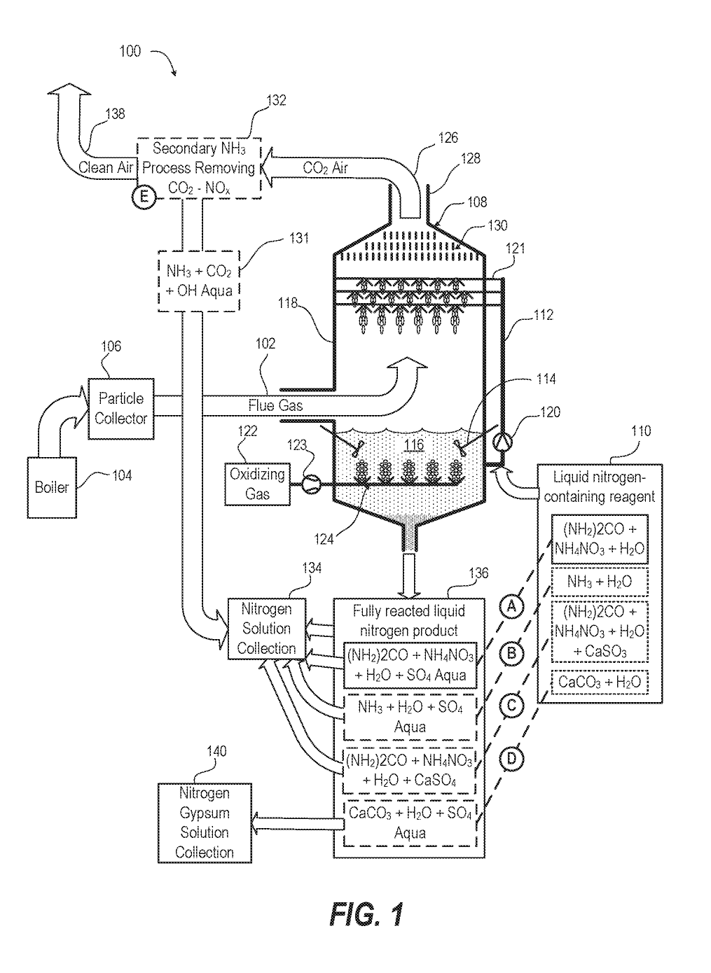

Now referring to FIG. 1, in the wet flue gas desulfurization (WFGD) system 100, a flue gas stream 102 leaves a boiler 104 and travels to a particle collector 106. Particle collector 106 may be a bag house, an electrostatic precipitator, a venturi-type scrubber or any similar apparatus that can facilitate the removal of particles from flue gas stream 102. Ash and other particulate contaminants (collectively referred to hereinafter as “fly ash”) present in flue gas stream 102 are collected in particle collector 106. The collected particulate contaminants may be disposed of or may be recycled within WFGD system 100.

After passing through particle collector 106, flue gas stream 102 travels to a wet scrubber 108. Wet scrubber 108 removes acidic gases such as sulfur dioxide (SO₂) from the flue gas stream 102 by exposing the flue gas stream 102 to a source 110 of a liquid nitrogen-containing reagent. The liquid nitrogen-containing reagent can be limestone, lime, or any other liquid nitrogen-containing compound, in a slurry, which is sprayed into flue gas stream 102 as droplets. The liquid nitrogen-containing reagent can be circulated within wet scrubber 108 by utilizing a slurry circulating line 112 to introduce the liquid nitrogen-containing alkaline reagent to wet scrubber 108. In particular, stirrers 114 stir a bottom fraction 116 within a wet scrubber vessel 118. A circulating pump 120 draws unreacted liquid nitrogen-containing reagent from an upper portion of the bottom fraction 116 via the slurry circulating line 112 and propels it upward to a spray tower 121. The reacted liquid nitrogen-containing reagent may be oxidized by introduction of an oxidizing gas 122 via a metering valve 123 that is released from nozzles 124 submerged in the bottom fraction 116.

After contacting the flue gas stream 102 with the alkaline reagent, a web scrubbed flue gas stream 126 is transported to a stack 128 for release into the atmosphere. Flue gas stream 126 may be subjected to other reagents, or one or more devices, that facilitate the removal of contaminants prior to being released into the atmosphere via stack 128, depicted as passing through a filter 130. Other treatments include, but are not limited to, mercury removal via contact with a reagent such as activated carbon, additional particulate collection, and the like.

In one embodiment, a supply 131 of ammonia or an ammonia precursor is added to the wet scrubbed flue gas stream 126 in a secondary ammonia process 132. Suitable ammonia precursors include urea, ammonium carbonate, ammonium carbamate, ammonium hydrogen carbonate, and ammonium formate. The ammonia or ammonia precursor can be introduced to the flue gas prior to entering, or within, a nitrogen solution collection 134. In an exemplary embodiment, the ammonia or ammonia precursor is introduced into the flue gas stream 126 at a point prior to the nitrogen solution collection 134 to allow good mixing of the ammonia or ammonia precursor in the flue gas to occur. The nitrogen solution collection 134 also receives from a bottom drain 136 the fully reacted liquid nitrogen-containing product from the wet scrubber vessel 118. Clean air stream 138 is then discharged into the atmosphere from the secondary ammonia process 132.

For clarity, FIG. 1 illustrates a source 110 of a liquid nitrogen containing reactant that as a first option “A” can include (NH₂)2CO+NH₄NO₃+H₂O and produces a fully reacted liquid nitrogen product of (NH₂)2CO+NH₄NO₃+H₂O+SO₄ Aqua. Alternatively, the source 110 of a liquid nitrogen containing reactant as an option “B” can include NH₃+H₂O and produces a fully reacted liquid nitrogen product of NH₃+H₂O+SO₄ Aqua. Alternatively, the source 110 of a liquid nitrogen containing reactant as an option “C” can include (NH₂)2CO+NH₄NO₃+H₂O+CaCO₃ and produces a fully reacted liquid nitrogen product of (NH₂)2CO+NH₄NO₃+H₂O+CaSO₄. Alternatively, the source 110 of a liquid nitrogen containing reactant as an option “D” can include limestone water CaCO₃+H₂O and produces a fully reacted liquid nitrogen product of nitrogen gypsum solution CaCO₃+H₂O+SO₄ Aqua that is separately collected in a nitrogen gypsum solution collection 140 from ammonia/sulfate solution collection 134 from the secondary ammonia process 132. Each of the options A-D can be combined with an option “E” of the secondary ammonia process 132.

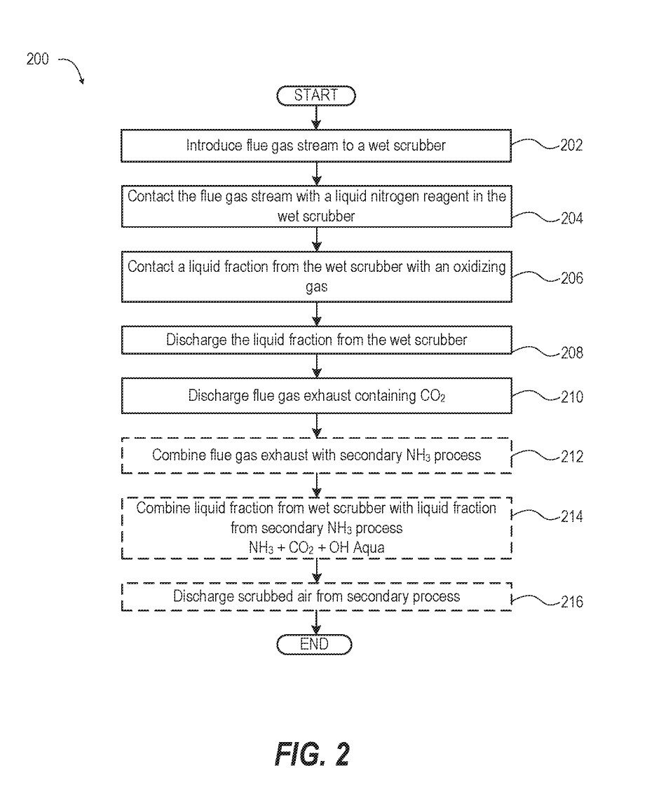

FIG. 2 illustrates a method 200 for removing sulfur from a flue gas stream in a wet scrubber. It is noteworthy that (any time nitrogen is added the system is also scrubbing CO₂. In one or more embodiments, the method 200 includes introducing a flue gas stream to a wet scrubber (block 202). The method 200 includes contacting the flue gas stream with a liquid nitrogen reagent in the wet scrubber (block 204). The method 200 includes contacting a liquid fraction in the wet scrubber with an oxidizing gas (block 206). The method 200 includes discharging the liquid fraction from the wet scrubber (block 208). In one or more embodiments, the method 200 includes discharging flue gas exhaust from the wet scrubber (block 210). The method 200 includes combining the flue gas exhaust with a secondary NH₃ process (block 212). The method 200 includes combining a secondary liquid fraction from the secondary NH₃ process that contains NH₃+CO₂+OH Aqua with the liquid fraction from the wet scrubber (block 214). The method 200 includes discharging scrubbed air from the secondary NH₃ process (block 216).

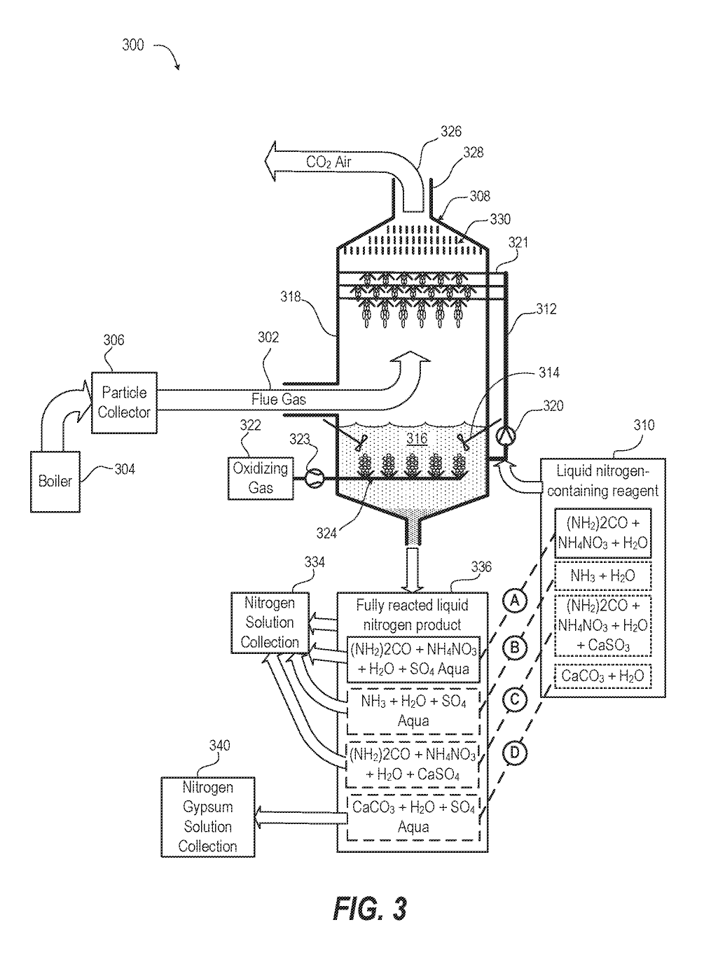

FIG. 3 illustrates a block diagram of one-stage WFGD system 300. A flue gas stream 302 leaves a boiler 304 and travels to a particle collector 306. Particle collector 306 may be a bag house, an electrostatic precipitator, a venturi-type scrubber or any similar apparatus that can facilitate the removal of particles from flue gas stream 302. Ash and other particulate contaminants (collectively referred to hereinafter as “fly ash”) present in flue gas stream 302 are collected in particle collector 306. The collected particulate contaminants may be disposed of or may be recycled within WFGD system 300.

After passing through particle collector 306, flue gas stream 302 travels to a wet scrubber 308. Wet scrubber 308 removes acidic gases such as sulfur dioxide (SO₂) from the flue gas stream 302 by exposing the flue gas stream 302 to a source 310 of a liquid nitrogen-containing reagent. The liquid nitrogen-containing reagent can be limestone, lime, or any other liquid nitrogen-containing compound, in a slurry, which is sprayed into flue gas stream 302 as droplets. The unreacted liquid nitrogen-containing reagent can be circulated within wet scrubber 308 by utilizing a slurry circulating line 312 to introduce the liquid nitrogen-containing alkaline reagent to wet scrubber 308. In particular, stirrers 314 stir a bottom fraction 316 within a wet scrubber vessel 318. A circulating pump 320 draws unreacted liquid nitrogen-containing reagent from an upper portion of the bottom fraction 316 via the slurry circulating line 312 and propels it upward to a spray tower 321. The reacted liquid nitrogen-containing reagent is fully oxidized by introduction of an oxidizing gas 322 via a metering valve 323 that is released from nozzles 324 submerged in the bottom fraction 316.

After contacting the flue gas stream 302 with the alkaline reagent, a web scrubbed flue gas stream 326 is transported to a stack 328 for release into the atmosphere. Flue gas stream 326 may be subjected to other reagents, or one or more devices, that facilitate the removal of contaminants prior to being released into the atmosphere via stack 328, depicted as passing through a filter 330. Other treatments include, but are not limited to, mercury removal via contact with a reagent such as activated carbon, additional particulate collection, and the like.

For clarity, FIG. 3 illustrates a source 310 of a liquid nitrogen containing reactant that as a first option “A” can include (NH₂)2CO+NH₄NO₃+H₂O and produces a fully reacted liquid nitrogen product of (NH₂)2CO+NH₄NO₃+H₂O+SO₄ Aqua. Alternatively, the source 310 of a liquid nitrogen containing reactant as an option “B” can include NH₃+H₂O and produces a fully reacted liquid nitrogen product of NH₃+H₂O+SO₄ Aqua. Alternatively, the source 310 of a liquid nitrogen containing reactant as an option “C” can include (NH₂)2CO+NH₄NO₃+H₂O+CaCO₃ and produces a fully reacted liquid nitrogen product of (NH₂)2CO+NH₄NO₃+H₂O+CaSO₄. Alternatively, the source 310 of a liquid nitrogen containing reactant as an option “D” can include limestone water CaCO₃+H₂O and produces a fully reacted liquid nitrogen product of nitrogen gypsum solution CaCO₃+H₂O+SO₄ Aqua that is separately collected in a nitrogen gypsum solution collection 340 from ammonia/sulfate solution collection 334 from the secondary ammonia process 332.

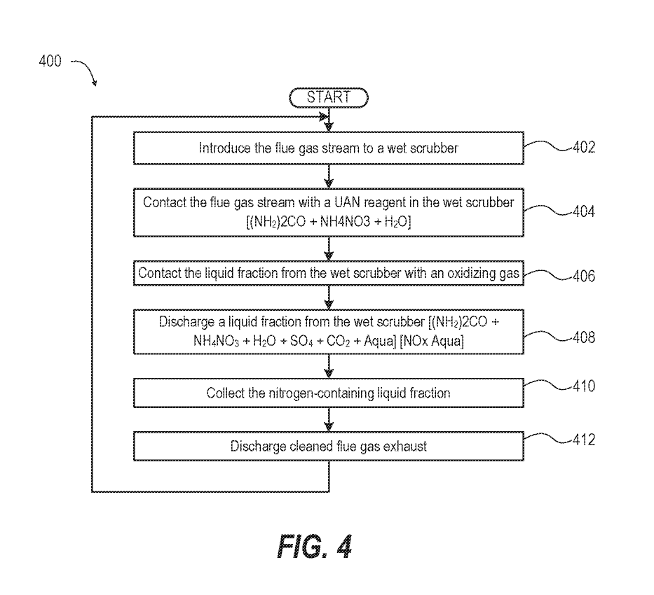

FIG. 4 illustrates a flow diagram of a method 400 of WFGD using single stage scrubbing, according to one or more embodiments. The method 400 includes introducing the flue gas stream to a wet scrubber (block 402). The method 400 includes contacting the flue gas stream with a UAN reagent in the wet scrubber {(NH₂)2CO+NH4NO3+H₂O} (block 404). The method 400 includes contacting the liquid fraction from the wet scrubber with an oxidizing gas (block 406). The method 400 includes discharging a liquid fraction from the wet scrubber ((NH₂)2CO+NH₄NO₃+H₂O+SO₄ Aqua) {NOx Aqua} (block 408). The method 400 includes combining the liquid fraction with secondary process (Ammonium/Sulfate Solution) (block 410). The method 400 includes discharging flue gas exhaust containing CO₂ (block 412).

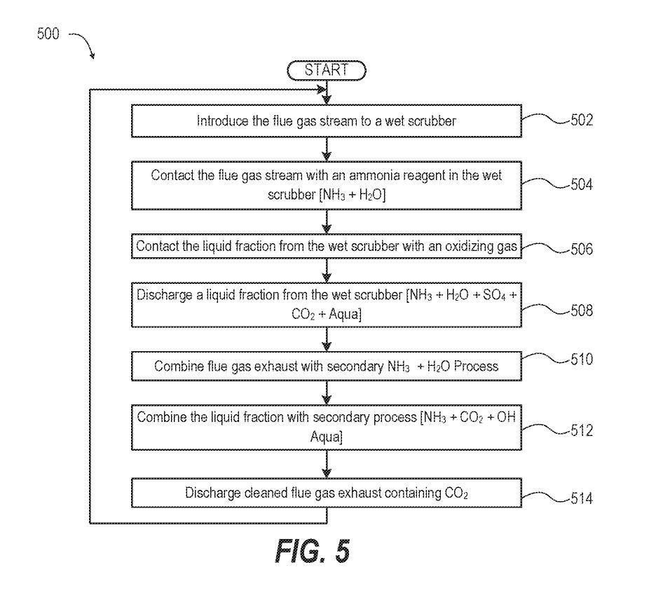

FIG. 5 illustrates a flow diagram of a method 500 of WFGD using NH3 (Aqua Only), according to one or more embodiments. The method 500 includes introducing the flue gas stream to a wet scrubber (block 502). The method 500 includes contacting the flue gas stream with an ammonia reagent in the wet scrubber {NH₃+H₂O} (block 504). The method 500 includes contacting the liquid fraction from the wet scrubber with an oxidizing gas (block 506). The method 500 includes discharging a liquid fraction from the wet scrubber {NH₃+H₂O+SO₄ Aqua} (block 508). The method 500 includes combining flue gas exhaust with secondary NH₃+H₂O Process (block 510). The method 500 includes combining the liquid fraction from the wet scrubber with liquid from the secondary process {NH₃+CO₂+OH Aqua} (block 512). The method 500 includes discharging flue gas exhaust containing CO₂ (block 514).

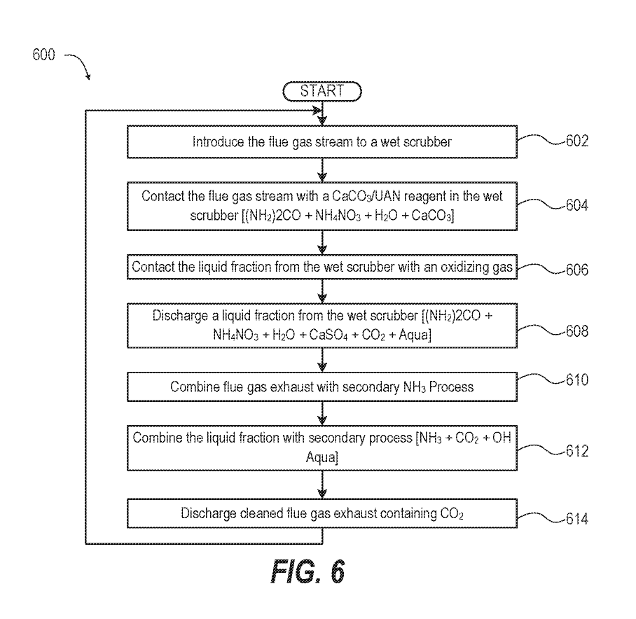

FIG. 6 illustrates a flow diagram of a method 600 of WFGD using (NH2)2CO+NH4NO3+H2O+CaCO3, according to one or more embodiments. The method 600 includes introducing the flue gas stream to a wet scrubber (block 602). The method 600 includes contacting the flue gas stream with an CaCO₃/UAN reagent in the wet scrubber {(NH₂)2CO+NH₄NO₃+H₂O+CaCO₃} (block 604). The method 600 includes contacting the liquid fraction from the wet scrubber with an oxidizing gas (block 606). The method 600 includes discharging a liquid fraction from the wet scrubber {(NH₂)2CO+NH₄NO₃+H₂O+CaSO₄ Aqua} (block 608). The method 600 includes combining flue gas exhaust with secondary NH₃ Process (block 610). The method 600 includes combining the liquid fraction with secondary process {NH₃+CO₂+OH Aqua} (block 612). The method 600 includes discharging flue gas exhaust containing CO₂ (block 614).

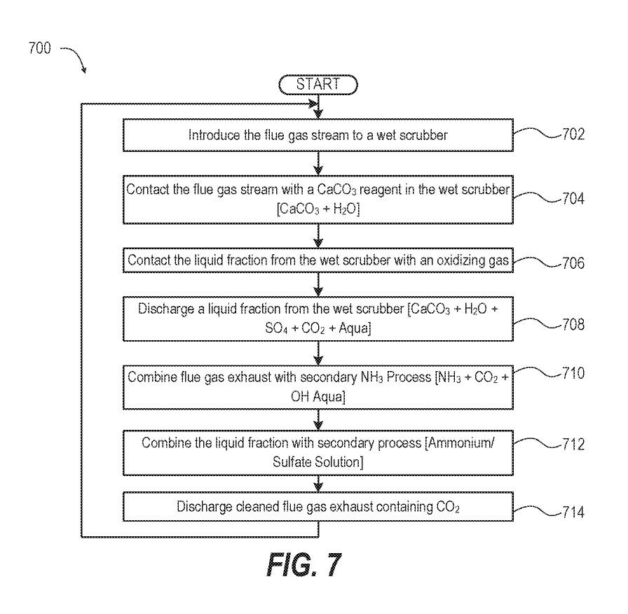

FIG. 7 illustrates a flow diagram of a method 700 of WFGD using a limestone water stage, according to one or more embodiments. The method 700 includes introducing the flue gas stream to a wet scrubber (block 702). The method 700 includes contacting the flue gas stream with an CaCO₃ reagent in the wet scrubber {CaCO₃+H₂O} (block 704). The method 700 includes contacting the liquid fraction from the wet scrubber with an oxidizing gas (block 706). The method 700 includes discharging a liquid fraction from the wet scrubber (CaCO₃+H₂O+SO4 Aqua) (block 708). The method 700 includes combining flue gas exhaust with secondary NH₃ Process {NH₃+CO₂+OH Aqua} (block 710). The method 700 includes combining the liquid fraction with secondary process {Ammonium/Sulfate Solution} (block 712). The method 700 includes discharging flue gas exhaust containing CO₂ (block 714).

In at least one embodiment, the liquid nitrogen reagent comprises a urea-ammonium nitrate (UAN) solution ((NH₂)2CO+NH₄NO₃+H₂O) and the reacted liquid nitrogen product comprises (NH₂)2CO+NH₄NO₃+H₂O+SO₄ Aqua. In at least one embodiment, the liquid nitrogen reagent comprises an ammonia reagent (NH₃+H₂O) solution and the reacted liquid nitrogen product comprises NH3+H2O+SO₄ Aqua. In at least one embodiment, the liquid nitrogen reagent comprises a calcium carbonate and urea-ammonium nitrate (UAN) solution ((NH₂)2CO+NH₄NO₃+H2O+CaCO₃ Aqua) and the reacted liquid nitrogen product comprises (NH₂)2CO+NH₄NO₃+H₂O+CaSO₄. In at least one embodiment, the liquid nitrogen reagent comprises a calcium carbonate solution (CaCO₃+H₂O) and the reacted liquid nitrogen product comprises CaCO₃+H₂O+SO₄ Aqua.

The amount of ammonia or ammonia precursor present in the flue gas is not considered critical, but preferably the molar ratio of ammonia to NOx (NO+NO₂) is in the range of 0.05 to 1.5, more preferably 0.6 to 1, so that preferably 5 to 100 percent and more preferably at least 60 percent, reduction of NOx can be achieved. In some embodiments, water may be added to increase efficiency of CO₂ removal.

Although the presence of oxygen is believed to be necessary for the reduction of nitrogen oxides in accordance with aspects of the present innovation, sufficient free oxygen generally remains mixed with the combustion gases leaving the regenerator for the process to occur. Additional oxygen can be added if insufficient oxygen is present, as for example where the regenerator is operated in an oxygen lean mode.

Wet scrubbers suitable for use in the present innovation can include gas phase scrubbers, liquid phase scrubbers, and combinations thereof. In one embodiment of the present invention, the wet scrubber is a liquid phase scrubber. Suitable liquid phase scrubbers include, without limitation, spray tower scrubbers including countercurrent, co-current, and crosscurrent designs, jet venturi scrubbers, and the like. In one detailed aspect, the liquid phase scrubber can be a spray tower scrubber. Suitable gas phase scrubbers include, without limitation, venturi scrubbers, e.g., fixed throat, variable throat, and adjustable throat designs; plate tower scrubbers, e.g., sieve, impingement, bubble-cap, and valve designs; orifice scrubbers, e.g., self-induced spray, inertial, and submerged orifice designs; and the like. Suitable combination liquid-gas phase scrubbers include, without limitation, wet film scrubbers, packed tower scrubbers, cyclonic spray scrubbers, mobile or moving bed scrubbers such as flooded bed and turbulent contact absorbers, baffle spray scrubber, mechanically aided scrubbers such as centrifugal fan and induced spray scrubbers, and the like.

Those skilled in the art will recognize a variety of wet scrubbers can be used and such are considered within the scope of the present invention. Further, specific wet scrubber designs not yet commercially available are also considered within the scope of the present invention. Currently, liquid phase scrubbers are the most preferred for removal of sulfur oxides and other toxic emissions. Further, it is noted that, as a general rule, wet scrubbers are more efficient at sulfur oxide reduction than dry scrubbers.

TYPES OF WET SCRUBBERS USED IN FGD: To promote maximum gas-liquid surface area and residence time, a number of wet scrubber designs have been used, including spray towers, venturis, plate towers, and mobile packed beds. Because of scale buildup, plugging, or erosion, which affect FGD dependability and absorber efficiency, the trend is to use simple scrubbers such as spray towers instead of more complicated ones. The configuration of the tower may be vertical or horizontal, and flue gas can flow co-currently, countercurrently, or crosscurrently with respect to the liquid. The chief drawback of spray towers is that they require a higher liquid-to-gas ratio requirement for equivalent SO removal than other absorber designs.

VENTURI-ROD SCRUBBERS: A venturi scrubber is a converging/diverging section of duct. The converging section accelerates the gas stream to high velocity. When the liquid stream is injected at the throat, which is the point of maximum velocity, the turbulence caused by the high gas velocity atomizes the liquid into small droplets, which creates the surface area necessary for mass transfer to take place. The higher the pressure drop in the venturi, the smaller the droplets and the higher the surface area. The penalty is in power consumption.

For simultaneous removal of SO and fly ash, venturi scrubbers can be used. In fact, many of the industrial sodium-based throwaway systems are venturi scrubbers originally designed to remove particulate matter. These units were slightly modified to inject a sodium-based scrubbing liquor. Although removal of both particles and SO in one vessel can be economic, the problems of high pressure drops and finding a scrubbing medium to remove heavy loadings of fly ash must be considered. However, in cases where the particle concentration is low, such as from oil-fired units, it can be more effective to remove particulate and SO simultaneously.

PACKED BED SCRUBBERS: A packed scrubber consists of a tower with packing material inside. This packing material can be in the shape of saddles, rings, or some highly specialized shapes designed to maximize contact area between the dirty gas and liquid. Packed towers typically operate at much lower pressure drops than venturi scrubbers and are therefore cheaper to operate. They also typically offer higher SO removal efficiency. The drawback is that they have a greater tendency to plug up if particles are present in excess in the exhaust air stream.

SPRAY TOWERS: A spray tower is the simplest type of scrubber. It consists of a tower with spray nozzles, which generate the droplets for surface contact. Spray towers are typically used when circulating a slurry. The high speed of a venturi would cause erosion problems, while a packed tower would plug up if it tried to circulate a slurry. Counter-current packed towers are infrequently used because they have a tendency to become plugged by collected particles or to scale when lime or limestone scrubbing slurries are used.

SCRUBBING REAGENT: As explained above, alkaline sorbents are used for scrubbing flue gases to remove SO₂. Depending on the application, the two most important are lime and sodium hydroxide (also known as caustic soda). Lime is typically used on large coal- or oil-fired boilers as found in power plants, as it is very much less expensive than caustic soda. The problem is that it results in a slurry being circulated through the scrubber instead of a solution. This makes it harder on the equipment. A spray tower is typically used for this application. The use of lime results in a slurry of calcium sulfite (CaSO₃) that must be disposed of. Fortunately, calcium sulfite can be oxidized to produce by-product gypsum (CaSO₄ 2H₂O), which is marketable for use in the building products industry.

Caustic soda is limited to smaller combustion units because it is more expensive than lime, but it has the advantage that it forms a solution rather than a slurry. This makes it easier to operate. It produces a “spent caustic” solution of sodium sulfite/bisulfite (depending on the pH), or sodium sulfate that must be disposed of. This is not a problem in a kraft pulp mill for example, where this can be a source of makeup chemicals to the recovery cycle.

SCRUBBING WITH SODIUM SULFITE SOLUTION: It is possible to scrub sulfur dioxide by using a cold solution of sodium sulfite, this forms a sodium hydrogen sulfite solution. By heating this solution it is possible to reverse the reaction to form sulfur dioxide and the sodium sulfite solution. Since the sodium sulfite solution is not consumed, it is called a regenerative treatment. The application of this reaction is also known as the Wellman-Lord process.

In some ways this can be thought of as being similar to the reversible liquid-liquid extraction of an inert gas such as xenon or radon (or some other solute which does not undergo a chemical change during the extraction) from water to another phase. While a chemical change does occur during the extraction of the sulfur dioxide from the gas mixture, it is the case that the extraction equilibrium is shifted by changing the temperature rather than by the use of a chemical reagent.

GAS PHASE OXIDATION FOLLOWED BY REACTION WITH AMMONIA: A new, emerging flue gas desulfurization technology has been described by the International Atomic Energy Agency (IAEA). It is a radiation technology where an intense beam of electrons is fired into the flue gas at the same time as ammonia is added to the gas. The Chendu power plant in China started up such a flue gas desulfurization unit on a 100 MW scale in 1998. The Pomorzany power plant in Poland also started up a similar sized unit in 2003 and that plant removes both sulfur and nitrogen oxides. Both plants are reported to be operating successfully. However, the accelerator design principles and manufacturing quality need further improvement for continuous operation in industrial conditions.

No radioactivity is required or created in the process. The electron beam is generated by a device similar to the electron gun in a TV set. This device is called an accelerator. This is an example of a radiation chemistry process where the physical effects of radiation are used to process a substance.

The action of the electron beam is to promote the oxidation of sulfur dioxide to sulfur(VI) compounds. The ammonia reacts with the sulfur compounds thus formed to produce ammonium sulfate, which can be used as a nitrogenous fertilizer. In addition, it can be used to lower the nitrogen oxide content of the flue gas. This method has attained industrial plant scale.

FLUE GAS DESULFURIZATION: Lime plays a key role in many air pollution control applications. Lime is used to remove acidic gases, particularly sulfur dioxide (SO2) and hydrogen chloride (HCl), from flue gases. Lime-based technology is also being evaluated for the removal of mercury.

Lime is more reactive than limestone, and requires less capital equipment. SO2 removal efficiencies using lime scrubbers range from 95 to 99 percent at electric generating plants. HCl removal efficiencies using lime range from 95 to 99 percent at municipal waste-to-energy plants.

There are two main methods for cleaning flue gases from coal combustion at electric generating stations: dry scrubbing and wet scrubbing. Lime is used in both systems. Dry scrubbing is also used at municipal waste-to-energy plants and other industrial facilities, primarily for HCl control.

DRY LIME SCRUBBING: In dry scrubbing, lime is injected directly into flue gas to remove SO2 and HCl. There are two major dry processes: “dry injection” systems inject dry hydrated lime into the flue gas duct and “spray dryers” inject an atomized lime slurry into a separate vessel.

A spray dryer is typically shaped like a silo, with a cylindrical top and a cone bottom. Hot flue gas flows into the top. Lime slurry is sprayed through an atomizer (e.g., nozzles) into the cylinder near the top, where it absorbs SO2 and HCl. The water in the lime slurry is then evaporated by the hot gas. The scrubbed flue gas flows from the bottom of the cylindrical section through a horizontal duct. A portion of the dried, unreacted lime and its reaction products fall to the bottom of the cone and are removed. The flue gas then flows to a particulate control device (e.g., a baghouse) to remove the remainder of the lime and reaction products.

Both dry injection and spray dryers yield a dry final product, collected in particulate control devices. At electric generating plants, dry scrubbing is used primarily for low-sulfur fuels. At municipal waste-to-energy plants, dry scrubbing is used for removal of SO2 and HCl. Dry scrubbing is used at other industrial facilities for HCl control. Dry scrubbing methods have improved significantly in recent years, resulting in excellent removal efficiencies.

WET LIME SCRUBBING: In wet lime scrubbing, lime is added to water and the resulting slurry is sprayed into a flue gas scrubber. In a typical system, the gas to be cleaned enters the bottom of a cylinder-like tower and flows upward through a shower of lime slurry. The sulfur dioxide is absorbed into the spray and then precipitated as wet calcium sulfite. The sulfite can be converted to gypsum, a salable by-product. Wet scrubbing treats high-sulfur fuels and some low-sulfur fuels where high-efficiency sulfur dioxide removal is required. Wet scrubbing primarily uses magnesium-enhanced lime (containing 3-8% magnesium oxide) because it provides high alkalinity to increase SO2 removal capacity and reduce scaling potential.

HCl REMOVAL: Because lime also reacts readily with other acid gases such as HCl, lime scrubbing is used to control HCl at municipal and industrial facilities. For example, at municipal waste-to-energy plants, dry lime scrubbing is used to control emissions from about 70 percent of the total U.S. capacity (as of 1998). HCl removal efficiencies using lime range from 95 to 99 percent. At secondary aluminum plants, for example, EPA identifies lime scrubbing as a maximum achievable control technology for HCl. EPA tests demonstrate removal efficiencies greater than 99 percent.

TOXIC EMISSIONS REMOVAL: In yet another detailed aspect of the present innovation, treatment of the flue gas can reduce toxic emissions in addition to sulfur oxides. Non-limiting examples of such toxic emissions include nitrogen oxides, carbon monoxide, arsenic, beryllium, cadmium, hydrochloric acid, chromium, cobalt, hafnium, lead, manganese, mercury, nickel, selenium, benzo(a)pyrene, and combinations thereof. In addition to sulfur oxide removal, various wet scrubbers can remove different toxic emissions to varying degrees. Thus, the choice of specific wet scrubbers can be tailored to affect a more complete removal of specific emissions. For example, wet scrubbers using a sorbent mix of lime and activated carbon can be used to reduce contaminants. Those skilled in the art can make such design choices based on the present invention as discussed herein.

In one embodiment of the present invention, a mercury removal device can be operatively connected to one of several locations depending on the types of system utilized. Currently, there are three broad categories of mercury removal technologies under development which include converting mercury into a solid which can then be removed with either a particulate control device or wet scrubber; adsorption of mercury on specific materials injected into the gas stream which can then be removed by either a particulate control device or wet scrubber; and converting mercury into a soluble form by injection of reagents which would then be removed by a wet scrubber. Such mercury removal systems can involve sorbent injection, particulate collection, catalyst or chemical additives, adsorbent units, and the like. In light of increasingly stringent environmental control regulations, improvements and developments in the area of mercury control are expected. Several non-limiting examples of current mercury removal systems include activated carbon injection, modified SCR/FGD systems, injection of partially combusted coal, silicate based adsorbents, flow over plated materials, halide combustions catalysts, and combinations of these technologies. Depending on the type of mercury removal system chosen, the injection of materials or reagents can occur in several possible locations including before or after an SCR, ESP or baghouse, wet scrubber, or can be a separate unit operatively connected to the system to treat the flue gas. Most of the current mercury removal systems suitable for use in the present invention can remove 90% or more of mercury from the flue gas.

In the above described methods, the method may be embodied in an automated manufacturing system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A method of removing sulfur from flue gas, the method comprising:
introducing a flue gas stream to a wet scrubber;
contacting the flue gas stream with a liquid nitrogen reagent in the wet scrubber that deposits in a bottom portion of the wet scrubber as a liquid fraction;
(contacting the liquid fraction from the wet scrubber with an oxidizing gas;
circulating liquid nitrogen reagent via sprayers in the wet scrubber to contact the flue gas stream;)
discharging reacted liquid nitrogen product from the wet scrubber that contains sulfur removed from the flue gas stream and that comprises a nitrogen and sulfur enriched fertilizer solution; and
discharging flue gas exhaust from the wet scrubber.

2. The method of claim 1, wherein the liquid nitrogen reagent comprises a urea-ammonium nitrate (UAN) solution ((NH₂)2CO+NH₄NO₃+H₂O) and the reacted liquid nitrogen product comprises (NH₂)2CO+NH₄NO₃+H₂O+SO₄ Aqua.

3. The method of claim 1, wherein the liquid nitrogen reagent comprises an ammonia reagent (NH₃+H₂O) solution and the reacted liquid nitrogen product comprises NH3+H2O+SO₄ Aqua.

4. The method of claim 1, wherein the liquid nitrogen reagent comprises a calcium carbonate (CaCO3) and urea-ammonium nitrate (UAN) solution ((NH₂)2CO+NH₄NO₃+H2O+CaCO₃ Aqua) and the reacted liquid nitrogen product comprises (NH₂)2CO+NH₄NO₃+H₂O+CaSO₄ (oxidized).

5. The method of claim 1, wherein the liquid nitrogen reagent comprises a calcium carbonate solution (CaCO₃+H₂O) and the reacted liquid nitrogen product comprises CaCO₃+H₂O+SO₄ Aqua.

6. The method of claim 1, further comprising combining the flue gas exhaust from the wet scrubber that contains carbon dioxide (CO₂) with a secondary ammonia (NH₃) process to produce a secondary liquid fraction comprising NH₃+CO₂+OH Aqua and to produce clean scrubbed air.

7. A system of removing sulfur from flue gas, the system comprising:
a wet scrubber to receive a flue gas stream from a boiler of a power generation plant;
a spray apparatus to contact the flue gas stream with a liquid nitrogen reagent in the wet scrubber that deposits in a bottom portion of the wet scrubber as a liquid fraction;
an oxidizer to contact the liquid fraction from the wet scrubber with an oxidizing gas; and
circulation pump to supply unreacted liquid nitrogen reagent from the bottom portion of the wet scrubber to the spray apparatus;
a collection to received discharged reacted liquid nitrogen product from the wet scrubber that contains sulfur removed from the flue gas stream for use as a nitrogen and sulfur enriched fertilizer solution; and
a stack to discharge flue gas exhaust from the wet scrubber.

8. The system of claim 7, wherein the liquid nitrogen reagent comprises a urea-ammonium nitrate (UAN) solution ((NH₂)2CO+NH₄NO₃+H₂O) and the reacted liquid nitrogen product comprises (NH₂)2CO+NH₄NO₃+H₂O+SO₄ Aqua.

9. The system of claim 7, wherein the liquid nitrogen reagent comprises an ammonia reagent (NH₃+H₂O) solution and the reacted liquid nitrogen product comprises NH3+H2O+SO₄ Aqua.

10. The system of claim 7, wherein the liquid nitrogen reagent comprises a calcium carbonate and urea-ammonium nitrate (UAN) solution ((NH₂)2CO+NH₄NO₃+H2O+CaCO₃ Aqua) and the reacted liquid nitrogen product comprises (NH2)2CO+NH₄NO₃+H₂O+CaSO₄.

11. The system of claim 7, wherein the liquid nitrogen reagent comprises a calcium carbonate solution (CaCO₃+H₂O) and the reacted liquid nitrogen product comprises CaCO₃+H₂O+SO₄ Aqua.

12. The system of claim 7, further comprising a secondary ammonia (NH₃) process that combines the flue gas exhaust from the wet scrubber that contains carbon dioxide (CO₂) with an ammonia solution to produce a secondary liquid fraction comprising NH₃+CO₂+OH Aqua and to produce clean scrubbed air.

13. A fertilizer product produced by a method of removing sulfur from flue gas, the method comprising:
introducing a flue gas stream to a wet scrubber;
contacting the flue gas stream with a liquid nitrogen reagent in the wet scrubber that deposits in a bottom portion of the wet scrubber as a liquid fraction;
contacting the liquid fraction from the wet scrubber with an oxidizing gas;
circulating liquid nitrogen reagent via sprayers in the wet scrubber to contact the flue gas stream;
discharging reacted liquid nitrogen product from the wet scrubber that contains sulfur removed from the flue gas stream and that comprises a nitrogen and sulfur enriched fertilizer solution; and
discharging flue gas exhaust from the wet scrubber.

14. The fertilizer product of claim 13, wherein the liquid nitrogen reagent comprises a urea-ammonium nitrate (UAN) solution ((NH₂)2CO+NH₄NO₃+H₂O) and the reacted liquid nitrogen product comprises (NH₂)2CO+NH₄NO₃+H₂O+SO₄ Aqua.

15. The fertilizer product of claim 13, wherein the liquid nitrogen reagent comprises an ammonia reagent (NH₃+H₂O) solution and the reacted liquid nitrogen product comprises NH3+H2O+SO₄ Aqua.

16. The fertilizer product of claim 13, wherein the liquid nitrogen reagent comprises a calcium carbonate and urea-ammonium nitrate (UAN) solution ((NH₂)2CO+NH₄NO₃+H2O+CaCO₃ Aqua) and the reacted liquid nitrogen product comprises (NH₂)2CO+NH₄NO₃+H₂O+CaSO₄.

17. The fertilizer product of claim 13, wherein the liquid nitrogen reagent comprises a calcium carbonate solution (CaCO₃+H₂O) and the reacted liquid nitrogen product comprises CaCO₃+H₂O+SO4 Aqua.

18. The fertilizer product of claim 13, wherein the method further comprises combining the flue gas exhaust from the wet scrubber that contains carbon dioxide (CO₂) with a secondary ammonia (NH₃) process to produce a secondary liquid fraction comprising NH₃+CO₂+OH Aqua and to produce clean scrubbed air.
